(19) United States
(12) Patent Application Publication
(10) Pub. No.: US 2019/0081718 A1
(43) Pub. Date: Mar. 14, 2019

(54) MEDIA SCHEDULING SYSTEM EMPLOYING ANONYMOUS CONTEXTUAL PAIRING

(71) Applicant: iHeartMedia Management Services, Inc., San Antonio, TX (US)

(72) Inventors: Bobbi Denise Schuster, San Antonio, TX (US); Matthew M. Ferry, Eastvale, CA (US); John W. Fulbright, Ogallala, NE (US); David C. Jellison, JR., Ogallala, NE (US); Kohinoor Basu, Aliso Viejo, CA (US); Steven M. Gable, San Antonio, TX (US); David R. Murray, Windemere, FL (US); Shaun Bruner, Bulverde, TX (US); Joseph Kubon, III, San Antonio, TX (US); Shawn Coffman, Ogallala, NE (US); Jason N. Lee, Orlando, FL (US); Mark R. Allen, Mission Viejo, CA (US); Chris Perluss, Mission Viejo, CA (US); Robert Gelb, Huntington Beach, CA (US)

(73) Assignee: iHeartMedia Management Services, Inc., San Antonio, TX (US)

(21) Appl. No.: 16/185,656

(22) Filed: Nov. 9, 2018

Related U.S. Application Data
(63) Continuation of application No. 12/533,872, filed on Jul. 31, 2009.
(60) Provisional application No. 61/129,961, filed on Aug. 1, 2008.

(51) Int. Cl. H04H 60/06; G06Q 30/02

(52) U.S. Cl. CPC H04H 60/06; G06Q 30/02

(57) ABSTRACT

An improved automated media scheduling system includes a conditional scheduler operating in cooperation with the at least one master scheduler to obtain a contextual condition associated with a conditional media item, and devoid of entity identification information. Satisfying the contextual condition is a prerequisite to pairing the conditional media item with another media item. The conditional scheduler obtains an original schedule generated by the master scheduler, identifies a scheduled media item, from the original schedule, that satisfies the contextual condition, pairs the conditional media item and the scheduled media item to generate a media item pair, and transmits a proposed scheduling change, including the media item pair, to the master scheduler. The master scheduler evaluates the proposed scheduling change for compliance with scheduling rules. Subject to the outcome of the evaluation, the generates an adjusted schedule including the proposed scheduling change, and generates a broadcast log based on the adjusted schedule.

### CROSS-REFERENCE TO RELATED APPLICATIONS

The present U.S. Utility patent application claims priority pursuant to 35 U.S.C. § 120 as a continuation of U.S. Utility application Ser. No. 12/533,872, entitled “PROVIDING CONDITIONAL ADVERTISING”, filed Jul. 31, 2009, which claims priority pursuant to 35 U.S.C. § 119(e) to U.S. Provisional Application No. 61/129,961, entitled “SYSTEM AND METHOD FOR PROVIDING CONDITIONAL ADVERTISING,” filed Aug. 1, 2008, all of which are hereby incorporated herein by reference in their entirety and made part of the present U.S. Utility patent application for all purposes.

### FIELD OF INVENTION

The present disclosure relates generally to automated media scheduling systems, and more particularly to media scheduling systems employing anonymous contextual pairing.

### BACKGROUND

Traditionally, media advertising and advertising systems have been treated as static availabilities of time slots that scheduling engines fill based on a variety of parameters. As such, each advertisement (“advert”) scheduled relies on a series of sequential rules and two-dimensional scheduling; the two dimensions typically being a date and time. Scheduling advertisements in this static manner may not extract the optimum advertising value from the advertisements.

### SUMMARY

According to some embodiments of the disclosure, advertisements can be paired in a way that has the potential to consistently provide greater advertising value than if the advertisements are otherwise scheduled. This pairing can be conditioned upon the context of the advertisements, and in various embodiments the pairing can be accomplished without compromising customer scheduling information and revealing advertiser identities.

In various embodiments, a method for use in scheduling spots to be aired includes receiving information identifying a preferred context in which a conditional spot is to be aired. This information includes an attribute of one or more scheduled spots, and in some embodiments is devoid of information specifically identifying a sponsor of the scheduled spot. The attribute can, in some instances, identify an industry with which the scheduled spot is associated, or a spot length. Based on the preferred context, a determination can be made about whether the conditional spot is to be paired with the scheduled spot.

In various embodiments the information identifying a preferred context includes multiple attributes, and each of the attributes is assigned a weighting factor. One or more of these weighting factors can be used to help determine whether the conditional spot is to be paired with a scheduled spot. In some instances, weighting factors can be assigned on a per-sponsor basis.

In response to determining that the conditional spot is to be paired with the scheduled spot, some embodiments perform the pairing to establish and air a campaign. However, the spots may not be paired if the pairing would conflict with a master schedule. Additionally, a threshold number of pairings can be set, so that a conditional spot may not be paired with a scheduled spot if there are too many conditional spots being paired with scheduled spots.

The performance of the campaign can be monitored to determine if campaign goals are met. If the campaign goals are not met, one or more weighting factors can be adjusted to generate at least one adjusted weighting factor. The campaign can then be adjusted to change the spots included in the campaign, based on the adjusted weighting factor.

Other embodiments include a system implementing a conditional-spots rules-engine. The system includes at least one processor, memory operably associated with the processor, and a program of instructions configured to be stored in the memory and executed by the processor to implement a conditional-spots rules engine. In some embodiments the system also includes a master scheduler, an enterprise hub system, and multiple broadcast systems configured to operate in cooperation with the enterprise hub system. In various embodiments, the program of instructions includes at least one instruction to balance placement of spots across multiple broadcast systems.

Various embodiments can also be implemented as a computer readable medium tangibly embodying a program of instructions configured to be stored in a memory and executed by a processor. The program of instructions includes at least one instruction to receive information identifying a preferred context in which a conditional spot is to be aired, including an attribute of at least a scheduled spot. The program of instructions also includes at least one instruction to determine whether the conditional spot is to be paired with the scheduled spot based, at least in part, on the preferred context.

### BRIEF DESCRIPTION OF THE DRAWINGS

The detailed description will refer to the following drawings, wherein like numerals refer to like elements, and wherein:

FIG. 1 is a flowchart illustrating an embodiment of a method for providing conditional advertising.

FIG. 2 is a block diagram illustrating an embodiment of a system for providing conditional advertising.

FIG. 3 is a block diagram illustrating an embodiment of a system for providing conditional advertising with a parent system for advertising scheduling.

FIG. 4 is a block diagram illustrating architecture of an embodiment of a system for scheduling and running advertising with an embodiment of a system for providing conditional advertising.

FIG. 5 is a diagram illustrating an exemplary screen for inputting and editing rules for conditional advertising in an embodiment of a system and method for providing conditional advertising.

FIG. 6 is a diagram illustrating an exemplary screen for inputting and editing rules for conditional advertising in an embodiment of a system and method for providing conditional advertising.

FIG. 7 is a diagram illustrating an exemplary screen for inputting and editing rules for conditional advertising in an embodiment of a system and method for providing conditional advertising.

FIG. 8 is a diagram illustrating an exemplary screen for inputting and editing rules for conditional advertising in an embodiment of a system and method for providing conditional advertising.

FIG. 9 is a diagram illustrating an exemplary screen for inputting and editing rules for conditional advertising in an embodiment of a system and method for providing conditional advertising.

FIG. 10 is a diagram illustrating an exemplary screen for reviewing rule input for conditional advertising in an embodiment of a system and method for providing conditional advertising.

FIG. 11 is a diagram illustrating an exemplary screen for uploading audio for conditional advertising in an embodiment of a system and method for providing conditional advertising.

FIG. 12 is a diagram illustrating an exemplary screen for conducting audio review of conditional advertising in an embodiment of a system and method for providing conditional advertising.

### DETAILED DESCRIPTION

Described herein are embodiments of a system and method for providing conditional advertising. The terms “Conditional Advertising” and “Conditional Spots” are used generally to describe the ability to conditionally pair one advertising unit to another based on some business rule sets (conditions). Various embodiments use contextual conditions used to determine the marriage or pairing (e.g. Industry elements) of advertising units. Such contextual conditions can be used to allow for a certain level of anonymity from and between respective advertisers; indeed, it is possible for an advertiser to request or have requested pairings without knowing the identity of the parent advertiser (the advertiser of the parent or main ad with which advertisement is paired). In practice this ability can be used to create a “natural” pairing of advertising elements so the effectiveness of each element is enhanced. For example, a restaurant ad followed by a payment method ad can creates a value of the whole higher than the sum of the parts. Note that the terms “spots”, “ads”, “adverts” and other similar terms are used interchangeably here.

Certain embodiments operate as a child subsystem or process under control of a parent scheduling system and process. Such embodiments open the door for more functionality to be coupled to the parent scheduler. This additional functionality may add a third, or additional, dimension to the ordinarily two-dimensional scheduling process. Instead of just time and day, industry type requirements, multi-day and multi-station pairing, etc., can provide additional scheduling dimensions.

Prior art teaches that advertisements are moved based on a fundamental set of static rules, which typical apply a framework for placement with a weighting algorithm. Various embodiments described herein provide a conditional spot scheduler that can “plug into” a master scheduler, accordingly adding depth and capability to the scheduling process. The master scheduler is constantly manipulating placements of ads in the future. The conditional spots scheduler analyzes these placements and reacts to add conditional pairs where appropriate. If the master scheduler moves adverts such that the conditional placed rules conflicts with the master scheduler, the placements can be withdrawn until another opportunity exists.

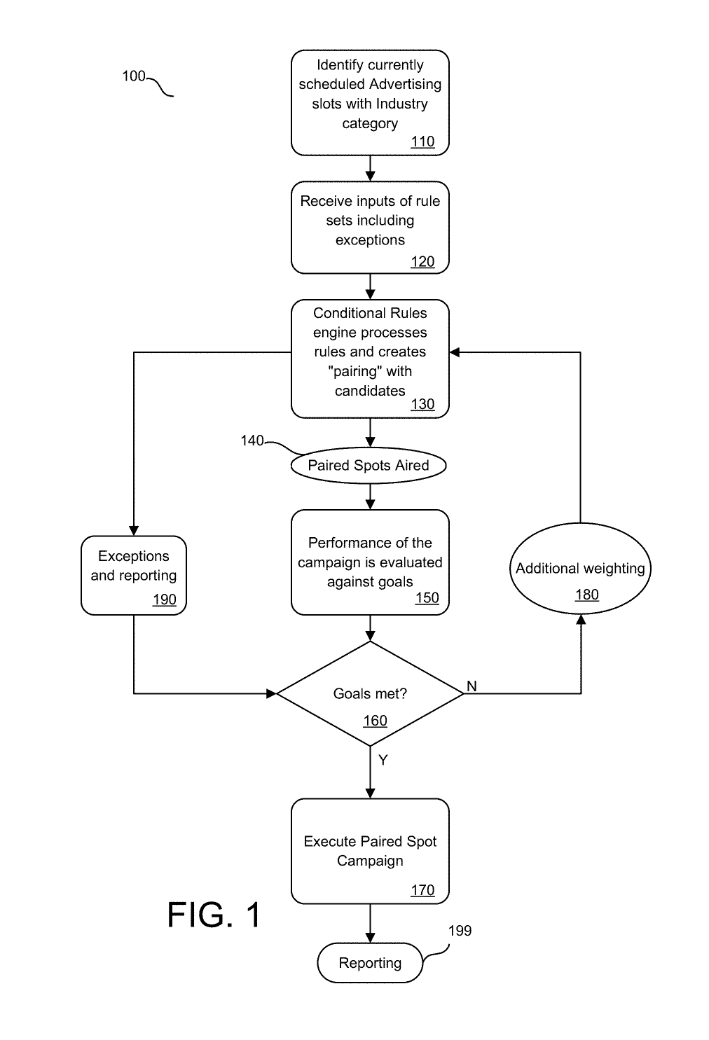

With reference now to FIG. 1, shown is an embodiment of a method 100 for providing conditional advertising. As illustrated at block 110, current scheduled advertising slots can be identified with an industry category. For example, if a 30 second airline advertisement or spot is scheduled at 1 PM on a given day and there is an immediately following slot available, that available slot will be identified with the airline industry category listed for the preceding schedule advertising. A conditional spots rules engine may receive information identifying current scheduled advertising slots from a master scheduler.

As illustrated at block 120, rules, conditions, and other input, for placing an advertisers conditional spots can be received by a device, system, subroutine, or other entity implementing method 100. Typically, this input is received from a user entering the rules into a system interface of conditional spots rules engine. The user may be an advertising sales person. In alternative embodiments, the input may be received from other components of the system. For example, advertiser may want spots conditionally placed with airline industry ads, retail ads, and entertainment ads, in that order of preference. Advertiser may want their conditional spots only placed after 30 second ads and may want their conditional spots only placed during primetime. A user can input these rules and conditions. In one or more embodiments, a user may weight these rules and conditions to reflect the priorities of the advertiser. Accordingly, placing with an airline industry ad would be weighted more than with a retail ad, increasing likelihood that advertiser's conditional spot would be placed with airline industry advertisement. A user may also input the advertiser's goals for their conditional spots. For example, the advertiser's goals may be number of impressions, etc. Likewise, a user may enter rules and weighting indicating the importance of the particular advertiser versus other advertisers. An important part of at least one embodiment of method 10 is that a user and advertiser do not see the identity of potential parent ads with which conditional spots may be placed. In an embodiment, as shown, a user can specify priorities for pairing based on type of industry. In this manner, conditional spots may be paired anonymously.

As illustrated at block 130, advertisements can be paired based on rules and conditions, and weighting if any, input by a user. In at least one embodiment, a conditional rules engine (e.g., a software program or routine) will process the rules and conditions and generate a pairing of the advertiser's conditional spots with scheduled ads. The pairings together are a campaign for the conditional advertiser. As noted above, an important part of some embodiments is that when pairings are created, user and advertiser do not see the identity of parent ads with which conditional spot is placed. In this manner, conditional ads can be paired anonymously.

As illustrated by block 140, a log of the paired conditional advertisements spots can be created and aired or sent to be aired. In some embodiments in which a conditional spots rules engine plugs into or otherwise provides input to a master scheduler, the proposed scheduled conditional spots are sent to the master scheduler at this point. The master scheduler may air the ads as paired or adjust their scheduled times per its requirements.

As illustrated by block 150, the performance of the campaign can be evaluated based on historical data. For example, the conditional rules engine may use data indicating how the paired ads performed (e.g., impressions or ratings indicating number of listeners receiving paired ads in campaign).

As illustrated at block 160, the evaluation is used to determination whether the advertiser's campaign goals are met. If the goals are met, the paired advertisement campaign continues to be executed, as illustrated by block 190,

As illustrated at block 170, if the goals are not met, the weighting of the paired spots can be adjusted. For example, the weighting of underperforming paired spots can be increased so that the underperforming spots are more likely to be paired with a first preference parent advertisement, or otherwise paired in a more preferential pairing (e.g., at a better time of day, with a more preferential parent ad, etc.). In some embodiments, conditional spots rules engine may automatically adjust the weighing, or the user can edit the inputted rules and weighting. An increased or additional weighting may be added only to certain rules and conditions, or weighting can be adjusted for all or substantially all rules and conditions. Furthermore, other input may be also edited. The advertisements can then be re-paired, creating new proposed pairings and campaigns, as illustrated at block 130. The new campaigns can be aired as illustrated at block 140, and the performance of the campaigns can be re-evaluated, as illustrated at block 150. In one or more embodiments, this is an iterative process that may be repeated until the goals are met.

When the proposed pairings and campaign are created, there may be exceptions indicating which rules cannot be met. For example, if four “movie” advertisement pairs are needed to satisfy the goals of a “movie club” advertiser pairing, but only three are scheduled, the user is alerted to this exception. Likewise, there may be other exceptions that occur while performance is being evaluated, such as paired ads not airing for a variety of reasons (e.g., master scheduler pre-empts paired ad). As illustrated by block 190, the exceptions can be delivered to an exception handling engine. Moreover, as paired ads air, reports can be generated to indicate to the user the details of the ads' airing.

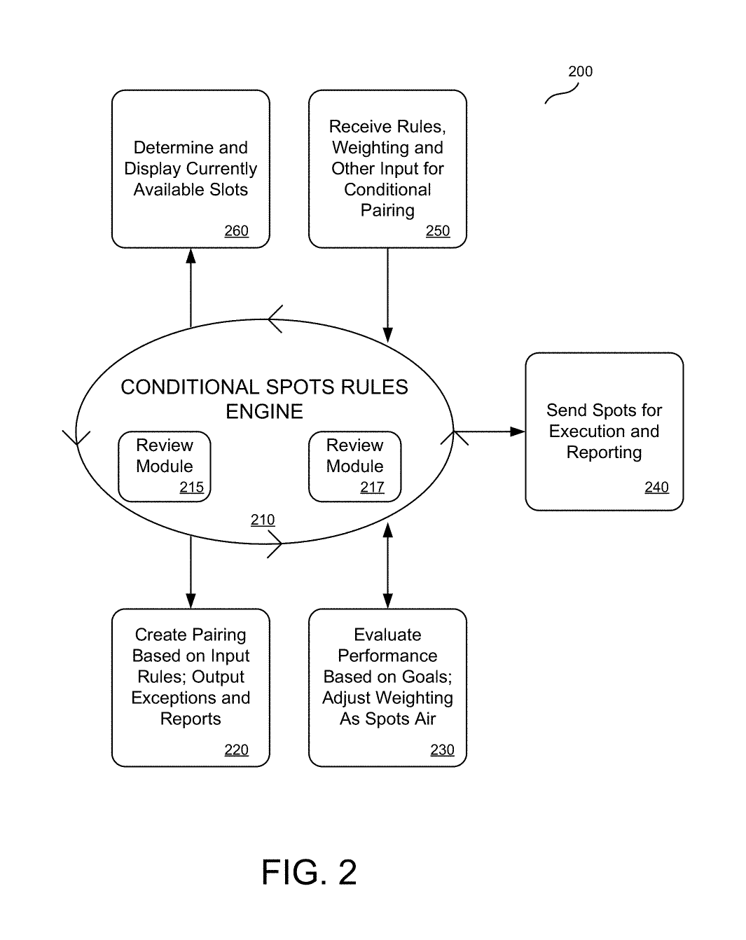

With reference now to FIG. 2, shown is an embodiment of system 200 for providing conditional advertising. As shown, system 200 includes conditional spots rules engine 210. Conditional spots rules engine 210 may run on a general purpose computer, a server or similar device. Conditional spots rules engine 210 may be accessible from a work station or over the Internet or other network.

The Conditional spots rules engine 210 may be a portal application. An embodiment of this application can be embedded in a portal architecture that contains all necessary interfacing to the conditional spots system. In one or more embodiments, the application leverages portal technology by plugging into the portal technology framework, which is generally the outward facing component to each user or customer.

System 200 may also include an audio review module 215. In embodiments in which the interface contains the advertising order and the audio component of the advertising, audio review module 215 allows review of the actual audio to be married with the pair's advertisements. The review can be used to provide JIT (just in time) functionality for the audio execution (airing). Audio review module 215 can be used to allow ads to be changed and reviewed just prior to airing.

As shown, conditional spots rules engine 210 can determine and display currently available slots as illustrated at 260. In at least one embodiment, conditional spots rules engine 210 receives this information from a master scheduler. The information may be displayed on a user interface for viewing by a user. Conditional spots rules engine 210 receives rules, weighting, and other input for conditional pairing of spots as illustrated at 250. As mentioned above, this input may be provided by a user. Conditional spots rules engine 210 creates pairings based on the rules and other input as illustrated at 220. Exceptions and other reports may be output. The paired spots can be sent to a master scheduler, for execution and reporting as illustrated at 240. Conditional spots rules engine 210 can also evaluate the performance of paired conditional spots as illustrated at 230. If the performance meets goals set by a user, the conditional spots campaign continues to air. If not, the conditional spots rules engine may adjust weighting and re-pair the conditional spots, also as illustrated at 230. This is an iterative process that may continue until goals are met.

With continued reference to FIG. 2, system 200 may include a reporting engine 217, which can be used to allow a user to select an As-Run report or a Campaign report. The criteria for each report are fed into the reporting engine where results are returned for viewing and printing.

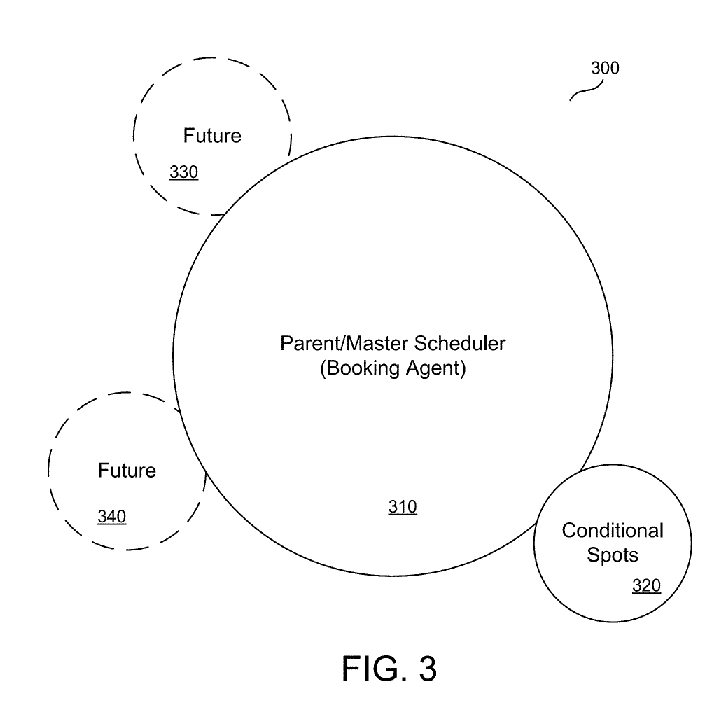

With reference now to FIG. 3, shown is a diagram illustrating an embodiment of a system 300 for providing conditional advertising in relationship to a parent scheduler. In the embodiment shown, system 300 provides inputs and request to the parent or master scheduler 310. In various embodiments master scheduler 310 ultimately controls the scheduling of ads and conditional spots system 320 is subservient or secondary to master scheduler 310. In other words, a master scheduler 310 may change the schedule based on input from conditional spots system 320, but in at least one embodiment conditional spots system 320 cannot a change a schedule produced by master scheduler 310. Master scheduler 310 may have certain slots available for conditional spots; conditional spots system 320 may only schedule conditional spots in those slots. Furthermore, it can be seen that conditional spots system 320 may be but one of multiple inputs into parent scheduler. There may be additional systems 330 and 340 providing scheduling input and requests to parent scheduler.

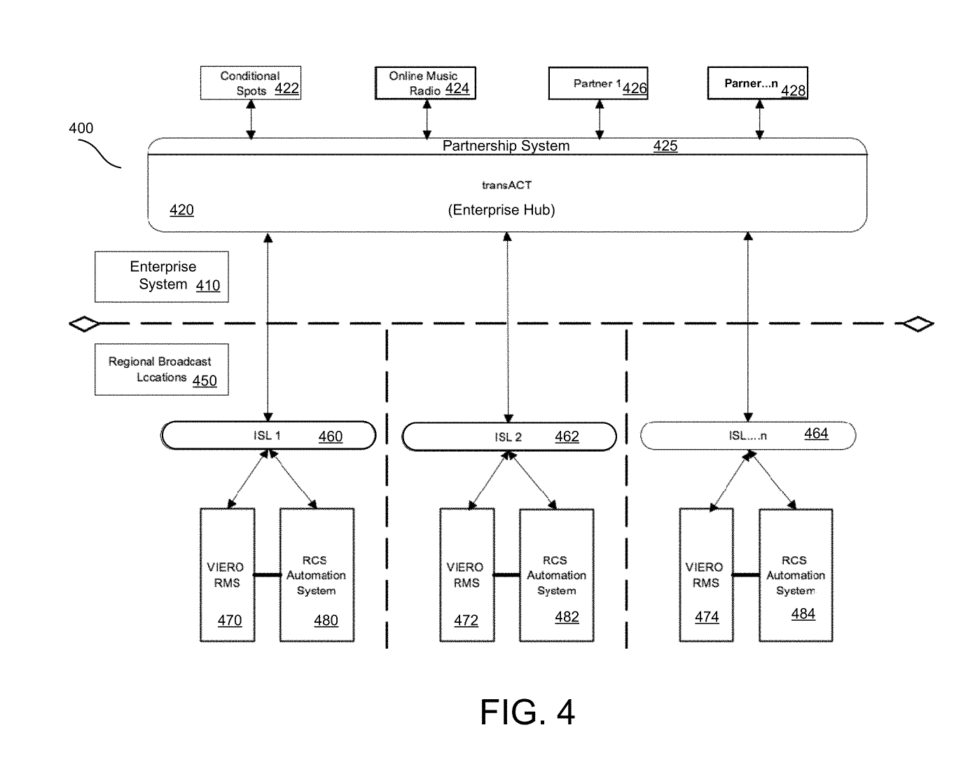

With reference now to FIG. 4, an embodiment of a system 400 for integrated, automated inventory management and advertisement delivery is illustrated. The inventory management and advertisement delivery system 400 is an example of an overall ad placement and scheduling system. Various embodiments of the inventory management and advertisement delivery system 400 include four major components. The first component is the local markets' Traffic and Billing Systems 480, 482, and 484; and Audio Delivery Systems 470, 472, and 474. These systems are transaction delivery components for order processing, billing and the content that is aired. In FIG. 4, Traffic and Billing Systems 480, 482, and 484 are illustrated as RCS Automation System (or, e.g., NexGen Digital system), and Audio Delivery Systems 470, 472, and 474 are illustrated as VIERO RMS. Audio Delivery Systems 470, 472, and 474 may include the master scheduler for the local market.

The second component is the local market Integrated Services Layer (ISL) Systems 460, 462, and 464. This system serves as a gateway to inject, extract, organize and route messages and audio into Traffic and Billing Systems 480, 482, and 484 and Audio Delivery Systems 470, 472, and 474 back and forth between regional broadcast locations 450 and the enterprise system 410.

The third major component is the Enterprise Hub (or electronic radio sales platform “ERSP” hub) 420. The ERSP 420 acts as the traffic cop for instructions, messages and audio content from the local ISL's and the partner layer. In essence the aggregation layer for all connected ISLs 460, 462, and 464 and partners. In the example shown, the ERSP 420 is labeled “transACT.”

The fourth component is the Partner system 425, which is the outward electronic interface to external partners 426 and 428 for transacting orders, provision of Audio content, and for reviewing proof of performance. Partners 426 and 428 are typically entities that act as advertising brokers, selling advertising in system. Usually partners are selling advertising on a national or regional level that is placed on local radio stations. Whatever advertising time slots (avails) that are not sold nationally by partners are left available to local radio stations to sell locally (e.g., to local advertisers). Combined, the components provide a mechanism to deliver from a centralize location order details and audio content in a near real time one-to-many fashion to multiple locations with automated acknowledgement and a high degree of guaranteed delivery for electronic messages.

In various embodiments, a conditional spot system 422 plugs into and provides input to the ERSP 420. In other words, conditional spot system 422 is on the same level in the inventory management and advertisement delivery system 400 as partner components such as online music radio 424. Conditional spot system 422 may receive slot available information from and provide scheduling input into ERSP 420 and ultimately a master scheduler (not illustrated). In various embodiments, a master scheduler for each market or station may sit in the Audio Delivery Systems 470, 472, or 474. Some embodiments include a common master scheduler for multiple markets. A single conditional spots rules engine instance may plug into any or all of these master schedulers. In effect, a single conditional spots rules engine may place conditional spots in multiple markets and/or stations. Consequently, the conditional spots rules engine may balance the placement of conditional spots across markets and stations, placing ads in different markets and stations to meet the demands and goals of advertisers; if one market is failing to meet the goals, the conditional spots rules engine may move spots to another market to meet those goals.

An exemplary embodiment of inventory management and advertisement delivery system is described in U.S. Provisional Patent Application No. 61/064,665, entitled “System and Method for Integrated, Automated Inventory Management and Advertisement Delivery,” filed Mar. 19, 2008 and herein incorporated by reference.

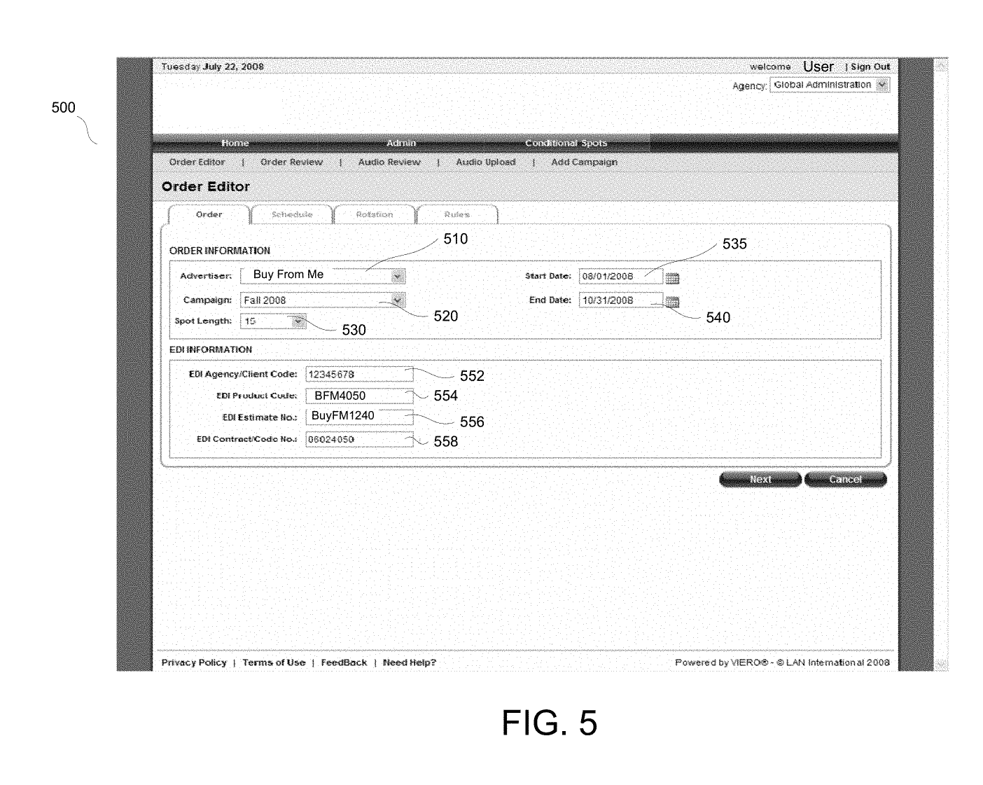

With reference now to FIG. 5, a screen shot of a graphical user interface (GUI) 500 for entering conditional spot placement details, or details relating to an order for placement of conditional spots. The screen shown here, and others discussed herein, enables the entering of conditional spot system receiving rules and conditions, and other input, for placing an advertisers conditional spots. As shown, a user may enter an advertiser 510, the advertiser's campaign name 520, the spot length 530, the spot start date 535 and the spot end date 540. In the example shown, the date range is a continuous date range, although multiple date ranges may be selected. This information may be entered, e.g., in a free-form text box or by being selected from a drop-down menu (e.g., advertisers, campaigns and other information may be pre-entered). Other information, such as an agency/client code 552 for partner or user placing order (e.g., EDI Agency/Client code) 552, a code and identifier that identifies and ties the order to invoices, e.g., EDI Product Code 554 and EDI Estimate No. 556, and a contract or code number indicating the specific advertisement contract with the advertiser, e.g., EDI Contract/Code No., 558. As can be seen, the order screen shown may be accessed by selection of a tab displayed at the top of the screen.

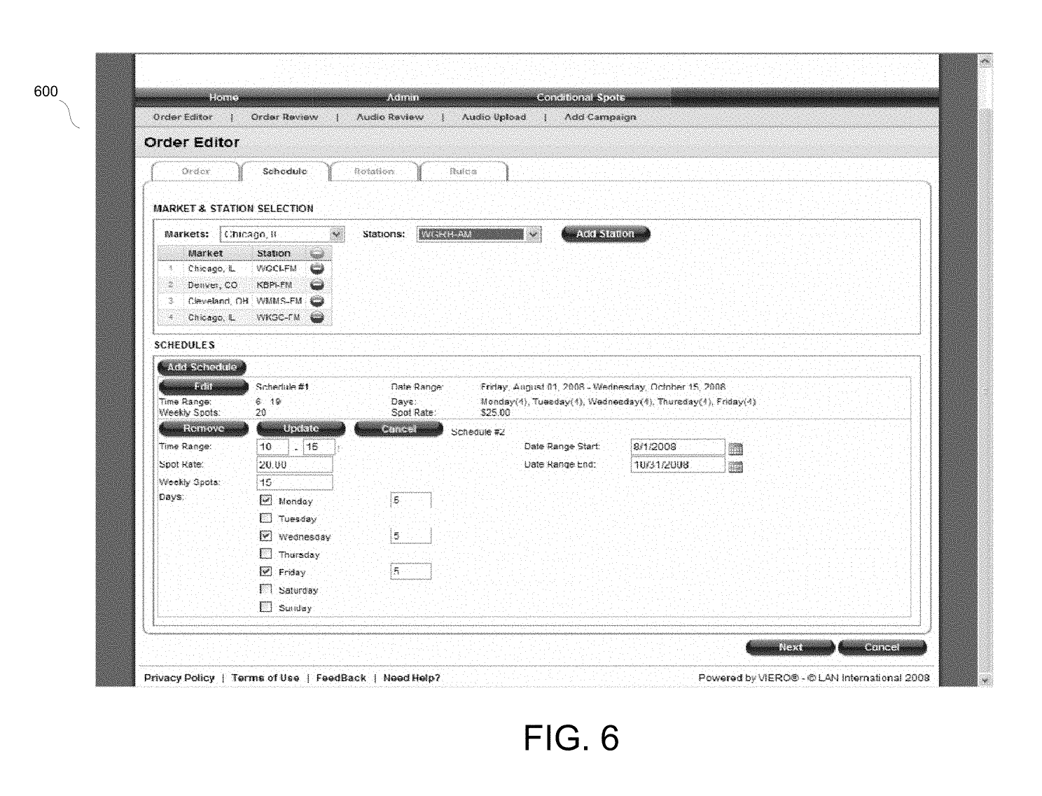

With reference now to FIG. 6, shown is a screen shot of a GUI 600 for entering conditional spot placement details, or details relating to an order for placement of conditional spots. This screen shown allows a user to select markets and stations within selected markets. The markets and stations are markets and stations in which, or on which, the conditional spots are to be aired (or at least are desired to be aired). In the example shown, Chicago, Denver and Cleveland are selected markets, while WGCI-FM and WKSC-FM are selected Chicago stations, KBPI-FM is a selected Denver station and WMMS-FM is a selected Cleveland station.

The user may also enter one or more schedules for conditional spots. Schedules are, in various embodiments, sets of rules or conditions for airing a conditional spot, such as the conditional spot identified on a GUI such as the one discussed above with reference to FIG. 5. The conditions or rules in a schedule can include the date range, which are typically, but not necessarily, the same as the range for the campaign discussed with reference to FIG. 5, but may include only sub-range(s) within that campaign date range, time range (e.g., entered as day parts), a dollar rate for the spot (e.g., the spot rate, expressed in dollars per spot aired), the requested number of spots to be aired per week (e.g., weekly spots), the requested days for airing the spots (e.g., Monday-Sunday), and the requested number of airings per day (e.g., 5 per day). As shown, one schedule for the conditional spot has been entered and a second schedule is being entered. An order may include a single schedule, a few schedules or many schedules. The conditional spots rules engine can process the input entered by the user and attempt to air the scheduled spots on the selected stations in the selected markets.

In the embodiment show, the conditional spot rules engine can statically attempt to place the scheduled spots in the selected stations and in the selected markets as specified. For example, if an order schedule indicates 20 spots, 4 each on M-F, for four stations, the conditional spot rules engine will seek to schedule 20 spots, 4 each on M-F, on each of the four stations. In another instance, a user may specify that the 20 spots are to be divided amongst the four stations. In some embodiments, the conditional spots rules engine will dynamically adjust the scheduling so that if one station or market is underperforming, it may place more ads on another station (in the same or different market) or another market. For example, spots can be moved from one station to another, so that in a given week in which 20 spots were requested for each station, one station may only air 15 and another may air 25. The conditional spots rules engine may make these adjustments based on performance data received as described herein.

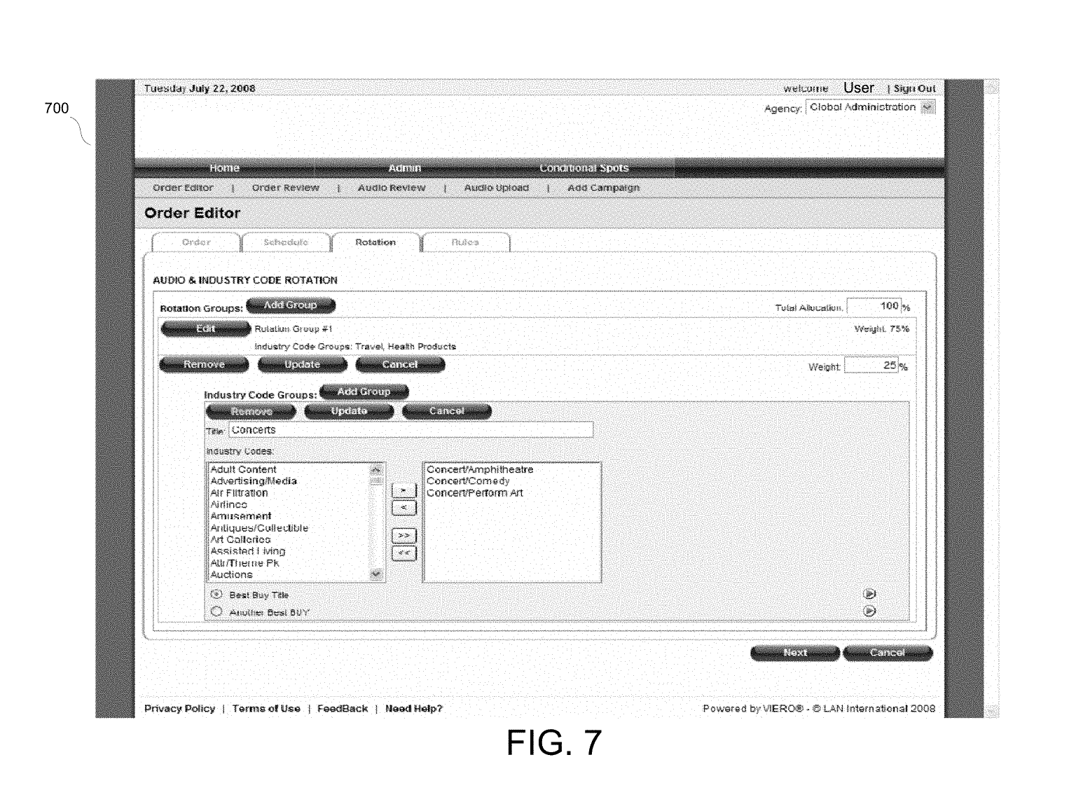

With reference now to FIG. 7, shown is a screen shot of a GUI 700 for entering conditional spot placement details, or details relating to an order for placement of conditional spots. The screen shown here enables a user to enter specific rules and conditions for pairing conditional spots. GUI 700 allows a user to create rotation groups, which can specify one or more industries the advertiser prefers to pair the conditional spots. As shown, the industry groups do not identify the parent advertisers, and in some embodiments are devoid of information identifying a parent advertiser. In this manner, the conditional spots rules engine can anonymously pair conditional spots.

Each rotation group may include one or more selected industry groups, and can include a designated weighting that indicates how many, by percentage or otherwise, of the conditional spots should ideally be paired with the industry group(s) in that rotation group. In some embodiments, the weighting can provide the relative importance of the designated rotation group. In an embodiment, the weightings of the rotations groups should add up to the total allocation of the conditional spot (e.g., 100%). As shown here, rotation group 1 was given a weighting of 75%. Rotation group 2 may have a maximum allocation of 25%. Each industry group in a rotation group may have designated sub-groups. For example, the designated industry for parent ads in a rotation group may be concerts. The designated sub-groups may be amphitheatre, comedy and performance art concerts. The terms “Buy From Me title” and “Another Buy From Me” refer to different spots (from Buy From Me). The spots may be selected for the rotation group (e.g., one spot or both spots selected for a given rotation group). In some embodiments, the user may enter as many rotation groups as desired, so long as the weighting of all rotation groups add up to the total allocation.

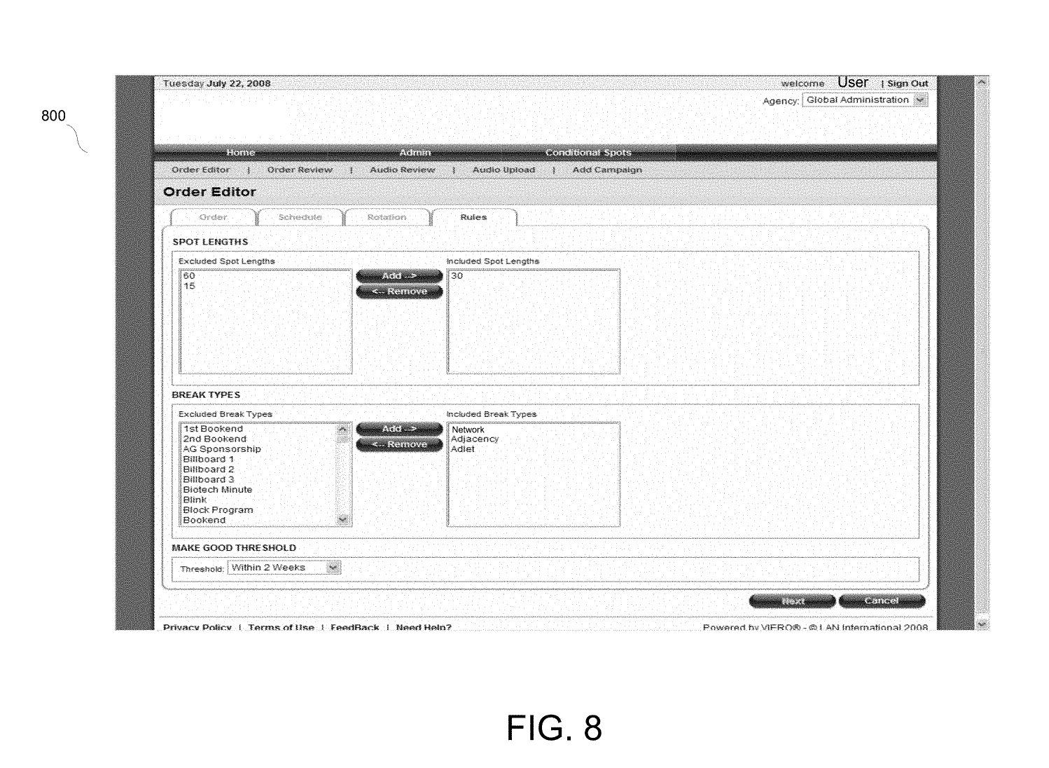

With reference now to FIG. 8, shown is screen shot of a GUI 800 for entering conditional spot placement details, or details relating to an order for placement of conditional spots. The screen shown here allows the user to enter additional rules and conditions for the pairing of conditional spots. A user may select which spot lengths to be included and/or excluded. This refers to the lengths of the parent spots with which the conditional spots will be aired. In the example shown, the user has included parent spot lengths of 30 seconds and excluded parent spot lengths of 60 and 15 seconds.

A user may also select which types of advertising breaks may be used for pairing the conditional spots. Stations typically have a variety of advertising breaks in which they air ads. An advertiser may not want their conditional spot placed in certain types of breaks and may desire their conditional spot be placed in certain types of breaks. Here, the user has included ABC network, adjacency and adlet breaks, and excluded others. The types of breaks may be defined as known to those of ordinary skill in the art and may be unique to a given company. The types of advertising breaks may be defined as having certain characteristics. For example, adlets are typically 5 seconds spots that are not joined to surrounding ads.

The user may also use GUI 800 to specify a make good threshold. Make Goods are agreed upon placements of ads in the event the originally scheduled ads do not air. These make goods in effect allow the radio stations to clean up from a failure rather than forfeit the revenue. Here the user has selected a make good threshold of within 2 weeks.

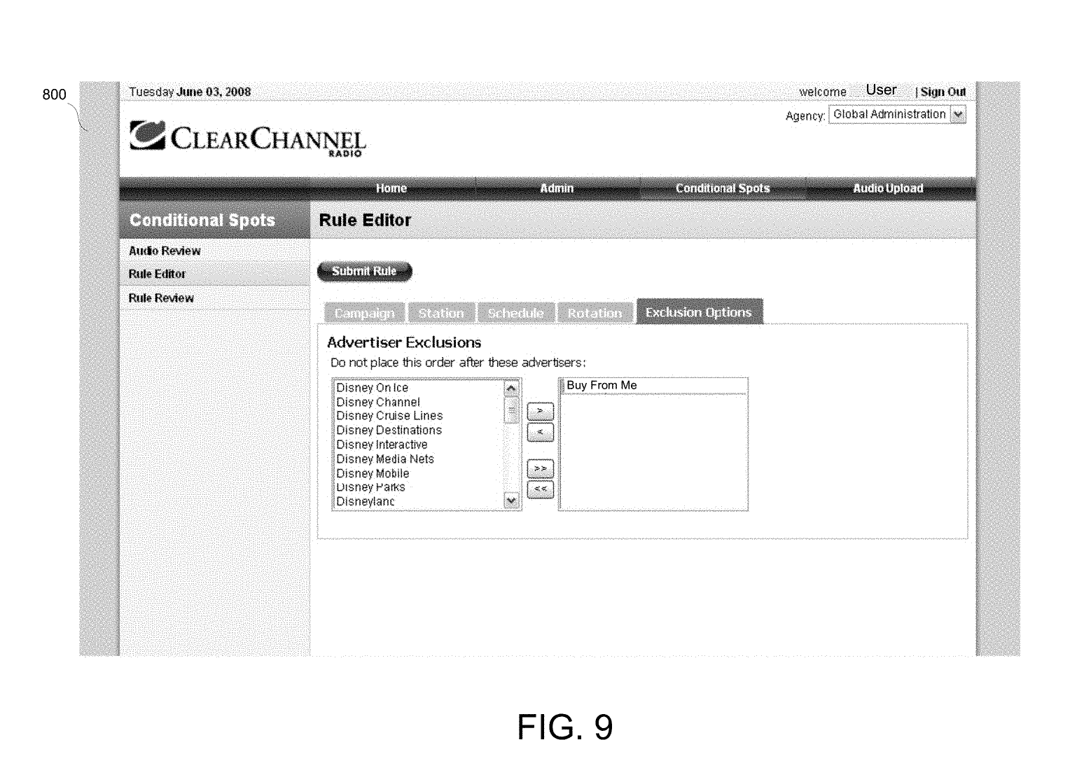

With reference now to FIG. 9, shown is a screen shot of a GUI 900 for entering conditional spot placement details, or details relating to an order for placement of conditional spots. The screen shown here allows the user to enter or edit certain exclusion rules. An advertiser may want to exclude certain advertisers from the potential pairings. For example, an advertiser may not want their conditional spot paired with a Buy From Me parent advertisement. The screen shown can, in some embodiments, include a list of advertisers available to be selected for exclusion. In some embodiments, inclusion in such a list does not indicate that such advertisers advertise, but just allows the user to exclude companies that would cause a conflict or problem for the conditional spot advertiser.

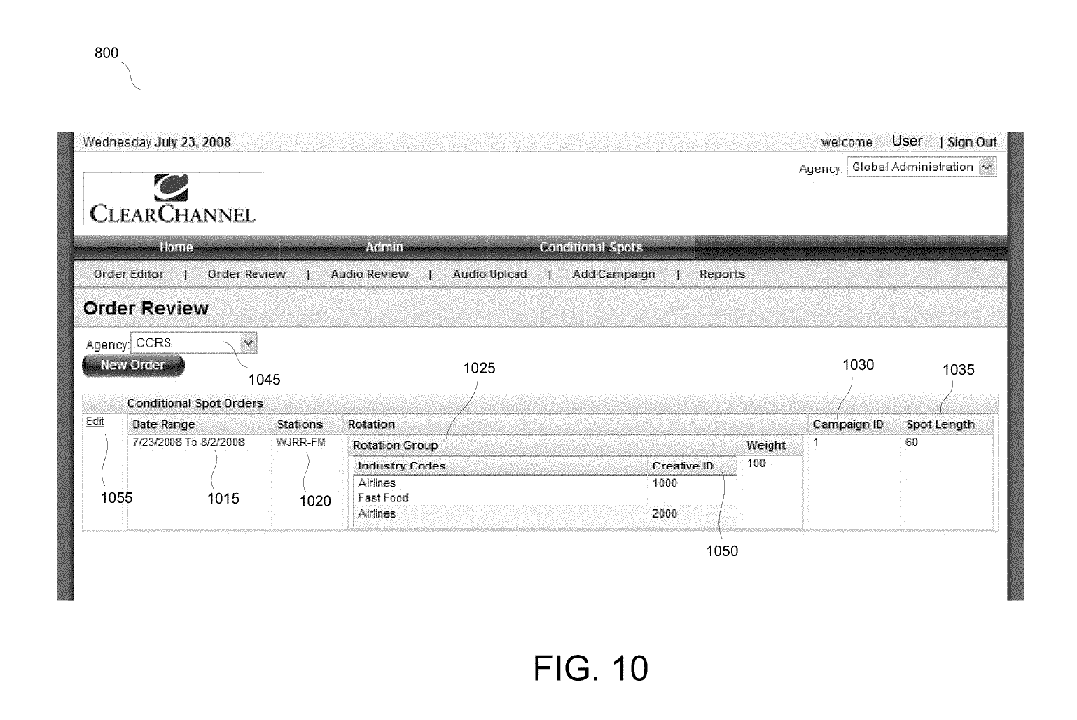

With reference now to FIG. 10, shown is a screen shot of a GUI 1010 for reviewing an order for the placement of a conditional spot or spots. As illustrated BUI 1010 displays a previously submitted conditional spot order. The order shows the date range for the order 1015, the stations selected 1020, the rotation groups 1025, the campaign ID 130 and the conditional spot length 1035. The advertising partner or agency 1045, here CCRS, may be shown. In the example shown, the date range is a continuous date range, although multiple date ranges may be selected. One station has been selected, although multiple stations may be selected. There is one rotation group, with a weighting of 100%, although multiple rotation groups may be entered. The illustrated rotation group 1025 includes three industry designations—airline is designated twice, and fast food. The creative ID 1050 identifies the conditional spot. The conditional spot length here is 60 seconds, although a variety of lengths may be chosen. An edit button or selection is available for a user to select to display screens to edit the order.

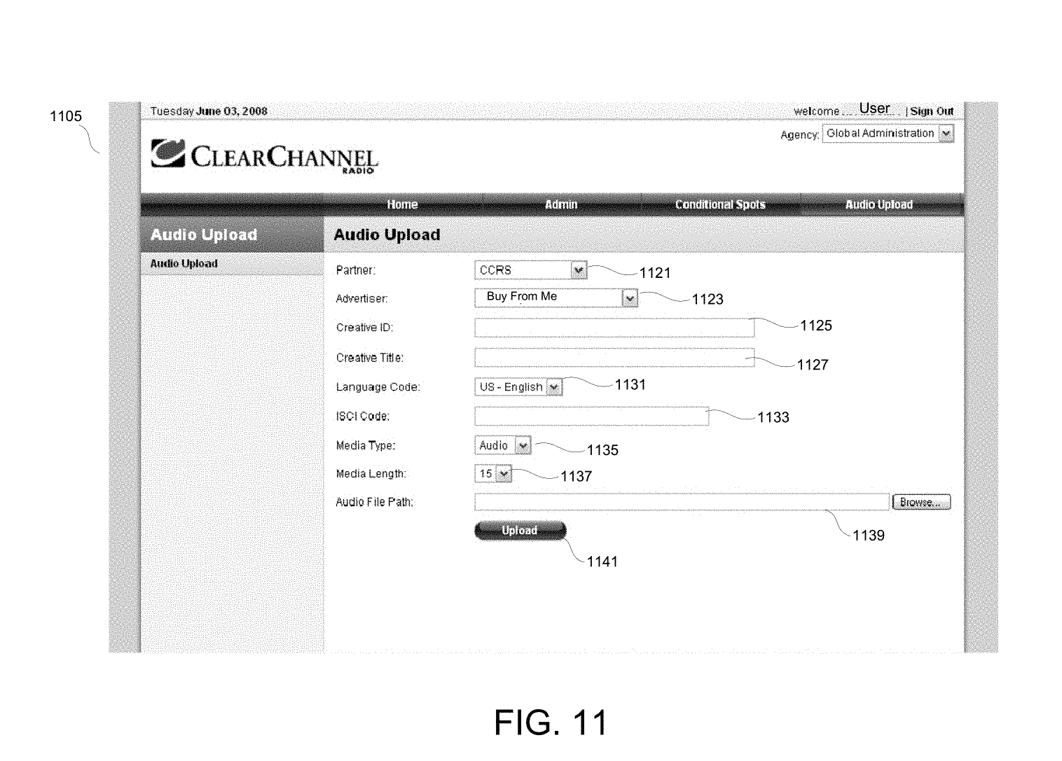

With reference now to FIG. 11, shown is screen shot of a GUI 1105 for uploading audio of a conditional spot or spots. In the screen shown, a user may upload the audio (and/or video in television embodiments) for a conditional spot. GUI 1105 allows a user to enter or select a partner 1121 (the agency that sells and places the ads), the advertiser 1123, the creative ID 1125 (e.g., a number identifying the conditional spot), the creative title 1127 (e.g., the title of the conditional spot), a language code 1131, a ISCI code 1133 (e.g., a unique identifier for advertisements used in the industry and known to those of ordinary skill in the art), a media type 1135 (e.g., audio, video, web page, photo, billboard, banner ad, etc.), the media length 1137 (e.g., 15, 30, 45, 60 seconds), and the file path for the conditional spot audio 1139. After all the information is entered, the user may select the upload button 1141 to upload the conditional spot.

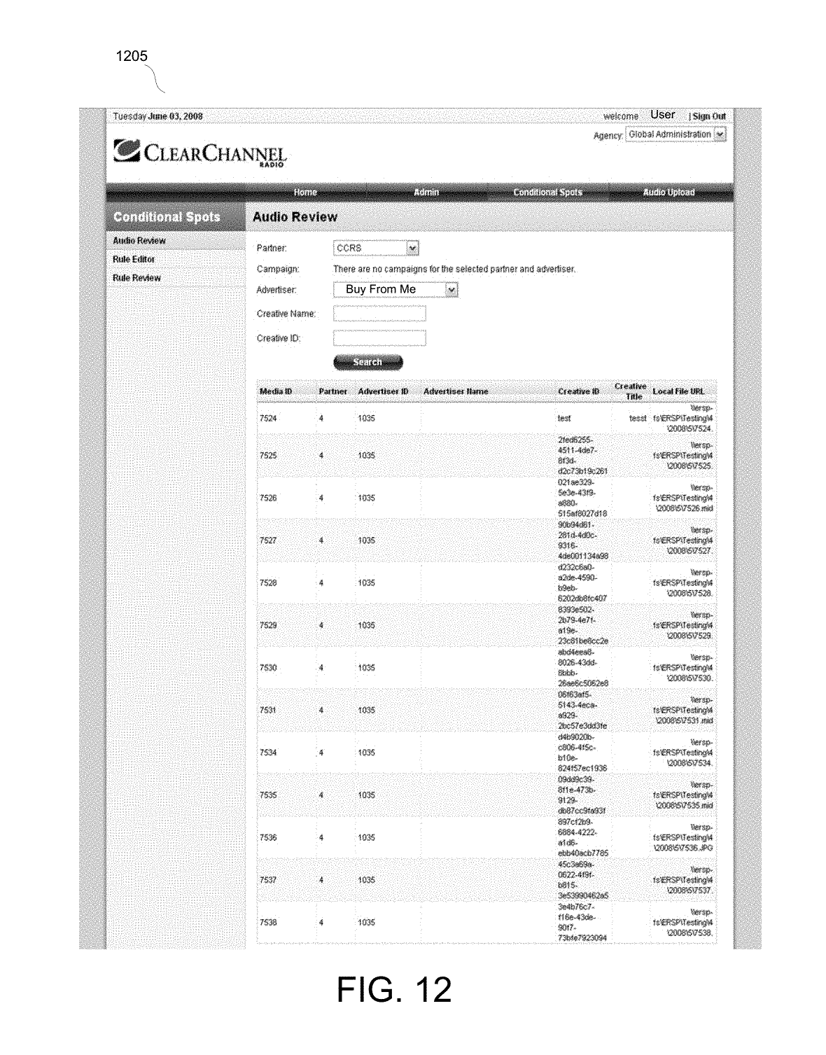

With reference now to FIG. 12, shown is a screen shot of a GUI 1205 for reviewing the uploaded audio of a conditional spot or spots. In the screen shown, the user may select audio (or other media) for review from a list of uploaded conditional spots. Selecting the audio will cause to be played so it may be reviewed. Alternatively, the user may search for the conditional spot audio by entering or selecting the partner, advertiser, campaign, creative ID and/or creative name, or otherwise. The user may review and approve/reject the audio of the conditional spot.

Various disclosed embodiments can be implemented in hardware, software, or a combination containing both hardware and software elements. In one or more embodiments, the invention is implemented in software, which includes but is not limited to firmware, resident software, microcode, etc. Some embodiments may be realized as a computer program product, and may be implemented as a computer-usable or computer-readable medium embodying program code for use by, or in connection with, a computer, a processor, or other suitable instruction execution system.

For the purposes of this description, a computer-usable or computer readable medium can be any apparatus that can contain, store, communicate, or transport the program for use by or in connection with an instruction execution system, apparatus, or device. By way of example, and not limitation, computer readable media may comprise any of various types of computer storage media, including volatile and non-volatile, removable and non-removable media implemented in any suitable method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Various embodiments have been described for delivering content related to a commercial media program. Other variations and modifications of the embodiments disclosed may be made based on the description provided, without departing from the scope of the invention as set forth in the following claims.

What is claimed is:

1. An improved automated media scheduling system, including at least one master scheduler that generates broadcast logs used to control a broadcast of media items on one or more media stations based on automated rule sets, wherein the improvement comprises:
a conditional scheduler operating in cooperation with the at least one master scheduler to:
obtain a contextual condition associated with a conditional media item, wherein satisfaction of the contextual condition is a prerequisite to pairing the conditional media item with another media item, and wherein the contextual condition is devoid of entity identification information;
obtain an original schedule generated by the at least one master scheduler, the original schedule including scheduled media items;
identify a scheduled media item that satisfies the contextual condition;
pair the conditional media item and the scheduled media item to generate a media item pair;
transmit a proposed scheduling change to the at least one master scheduler, the proposed scheduling change including the media item pair;
the at least one master scheduler to:
perform an evaluation of the proposed scheduling change for compliance with scheduling rules;
generate an adjusted schedule by altering the original schedule to include the proposed scheduling change, subject to a result of the evaluation; and
generate a broadcast log based on the adjusted schedule.

2. The improved automated media scheduling system of claim 1, wherein conditional scheduler is further configured to:
pair a plurality of different conditional media items with the scheduled media item to generate a plurality of media item pairs; and
wherein the proposed scheduling change includes the plurality of media item pairs.

3. The improved automated media scheduling system of claim 2, wherein:
the conditional scheduler is further configured to:
generate a plurality of proposed scheduling changes based on the plurality of media item pairs;
transmit different proposed scheduling changes to different master schedulers associated with different local media stations;
each of the different master schedulers is configured to:
perform an evaluation of a received proposed scheduling change for compliance with scheduling rules;
generate the adjusted schedule by altering the original schedule to include the received proposed scheduling change, subject to a result of the evaluation; and
generate a local broadcast log based on the adjusted schedule.

4. The improved automated media scheduling system of claim 3, wherein the conditional scheduler is further configured to:
obtain information related to particular media item pairs included in the different proposed scheduling changes; and
adjust the plurality of media item pairs included in the different proposed scheduling changes based on the information related to the plurality of media item pairs.

5. The improved automated media scheduling system of claim 2, wherein:
the conditional scheduler is further configured to transmit the proposed scheduling change to a single master scheduler serving a plurality of local media stations; and
the single master scheduler is further configured to transmit the broadcast log to the plurality of local media stations.

6. The improved automated media scheduling system of claim 1, wherein the at least one master scheduler is further configured to:
transmit the broadcast log from the at least one master scheduler to a plurality of local media stations via an integrated services layer.

7. The improved automated media scheduling system of claim 1, wherein:
the contextual condition includes a preferred industry attribute; and
wherein the conditional scheduler is further configured to identify the scheduled media item that satisfies the contextual condition by comparing an industry attribute associated with the scheduled media item to the preferred industry attribute.

8. A method for use in an automated media scheduling system integrating an enterprise system and local broadcasting systems, the method comprising:
at a conditional scheduler operating in cooperation with at least one master scheduler:
obtaining a contextual condition associated with a conditional media item, wherein satisfaction of the contextual condition is a prerequisite to pairing the conditional media item with another media item, and wherein the contextual condition is devoid of entity identification information;
obtaining an original schedule generated by the at least one master scheduler, the original schedule including scheduled media items;
identify a scheduled media item that satisfies the contextual condition;
pairing the conditional media item and the scheduled media item to generate a media item pair;
transmitting a proposed scheduling change to the at least one master scheduler, the proposed scheduling change including the media item pair;
at the at least one master scheduler:
evaluating the proposed scheduling change for compliance with scheduling rules;
generating an adjusted schedule by altering the original schedule to include the proposed scheduling change, subject to a result of the evaluating; and
generating a broadcast log based on the adjusted schedule.

9. The method of claim 8, further comprising:
at the conditional scheduler, pairing a plurality of different conditional media items with the scheduled media item to generate a plurality of media item pairs; and
wherein the proposed scheduling change includes the plurality of media item pairs.

10. The method of claim 9, further comprising:
at the conditional scheduler:
generating a plurality of proposed scheduling changes based on the plurality of media item pairs;
transmitting different proposed scheduling changes to different master schedulers associated with different local media stations; and
at each of the different master schedulers:
evaluating a received proposed scheduling change for compliance with scheduling rules;
generating the adjusted schedule by altering the original schedule to include the received proposed scheduling change, subject to a result of the evaluating; and
generating a local broadcast log based on the adjusted schedule.

11. The method of claim 10, further comprising:
at the conditional scheduler:
obtaining information related to particular media item pairs included in the different proposed scheduling changes; and
adjusting the plurality of media item pairs included in the different proposed scheduling changes based on the information related to the plurality of media item pairs.

12. The method of claim 9, further comprising:
at the conditional scheduler, transmitting the proposed scheduling change to a single master scheduler serving a plurality of local media stations; and
at the single master scheduler, transmitting the broadcast log to the plurality of local media stations.

13. The method of claim 8, further comprising:
transmitting the broadcast log from the at least one master scheduler to a plurality of local media stations via an integrated services layer.

14. The method of claim 8, wherein:
the contextual condition includes a preferred industry attribute; and wherein
identifying a scheduled media item that satisfies the contextual condition includes comparing an industry attribute associated with the scheduled media item to the preferred industry attribute.

15. An improved automated media scheduling system, including at least one master scheduler that generates broadcast logs used to control a broadcast of media items on one or more media stations based on automated rule sets, wherein the improvement comprises:
a conditional scheduler, operating in cooperation with the at least one master scheduler to:
obtain a contextual condition associated with a conditional media item, wherein:
satisfaction of the contextual condition is a prerequisite to pairing the conditional media item with another media item;
the contextual condition is devoid of entity identification information;
the contextual condition includes a preferred industry attribute for pairing;
obtain an original schedule generated by the at least one master scheduler, the original schedule including scheduled media items;
identify a scheduled media item that satisfies the contextual condition, at least in part by comparing an industry attribute associated with the scheduled media item to the preferred industry attribute for pairing;
pair the conditional media item and the scheduled media item to generate a media item pair;
transmit a proposed scheduling change to the at least one master scheduler, the proposed scheduling change including the media item pair;
the at least one master scheduler to:
perform an evaluation of the proposed scheduling change for compliance with scheduling rules;
generate an adjusted schedule by altering the original schedule to include the proposed scheduling change, subject to a result of the evaluation; and
generate a broadcast log based on the adjusted schedule.

16. The improved automated media scheduling system of claim 15, wherein conditional scheduler is further configured to:
pair a plurality of different conditional media items with the scheduled media item to generate a plurality of media item pairs; and
wherein the proposed scheduling change includes the plurality of media item pairs.

17. The improved automated media scheduling system of claim 16, wherein:
the conditional scheduler is further configured to:
generate a plurality of proposed scheduling changes based on the plurality of media item pairs;
transmit different proposed scheduling changes to different master schedulers associated with different local media stations;
each of the different master schedulers is configured to:
evaluate a received proposed scheduling change for compliance with scheduling rules;
generate the adjusted schedule by altering the original schedule to include the received proposed scheduling change, subject to a result of the evaluation; and
generate a local broadcast log based on the adjusted schedule.

18. The improved automated media scheduling system of claim 17, wherein the conditional scheduler is further configured to:
obtain information related to particular media item pairs included in the different proposed scheduling changes; and
adjust the plurality of media item pairs included in the different proposed scheduling changes based on the information related to the plurality of media item pairs.

19. The improved automated media scheduling system of claim 16, wherein:
the conditional scheduler is further configured to transmit the proposed scheduling change to a single master scheduler serving a plurality of local media stations; and
the single master scheduler is further configured to transmit the broadcast log to the plurality of local media stations.

20. The improved automated media scheduling system of claim 15, wherein the at least one master scheduler is further configured to:
transmit the broadcast log from the at least one master scheduler to a plurality of local media stations via an integrated services layer.
